(19) United States
(12) Patent Application Publication
(10) Pub. No.: US 2011/0117432 A1
(43) Pub. Date: May 19, 2011

(54) INORGANIC BINDERS FOR BATTERY ELECTRODES AND AQUEOUS PROCESSING THEREOF

(75) Inventor: Andreas Kay, Waldkirch (DE)

(73) Assignee: DOW GLOBAL TECHNOLOGIES LLC, Midland, MI (US)

(21) Appl. No.: 13/003,063

(22) PCT Filed: Jun. 15, 2009
(86) PCT No.: PCT/IB09/52543

§ 371 Date: Jan. 7, 2011

(30) Foreign Application Priority Data
Jul. 15, 2008 (IB) PCT/IB2008/052832

(51) Int. Cl. H01M 4/58; H01M 4/62; H01M 4/26

(52) U.S. Cl. 429/218.1; 429/232; 429/231.1; 29/623.5

(57) ABSTRACT

The present invention concerns battery electrodes, and more particularly rechargeable lithium battery electrodes, with active materials, containing an inorganic binder for cohesion between the electrode materials and adhesion to a current collector. These electrodes are produced from an aqueous slurry of active electrode materials, optionally conductive additives and a soluble precursor or nanoparticles or a colloidal dispersion of the inorganic binder by spreading the slurry on a current collector and drying.

### FIELD OF THE INVENTION

The present invention concerns battery electrodes, and more particularly rechargeable lithium battery electrodes containing an inorganic binder for cohesion between the electrode materials and adhesion to a current collector.

### STATE OF THE ART

Electrodes for batteries, such as rechargeable lithium batteries, are usually made from powders of the active material, optionally an electronically conductive additive, e.g. carbon, and a binder, which are dispersed in a solvent and applied as a coating on a current collector, such as aluminum or copper foil. The binder provides cohesion between the particles of active material and conductive additive as well as adhesion to the current collector.

For rechargeable lithium batteries fluorinated polymers, mainly poly(vinylidene fluoride) (PVdF), are generally employed, due to their good electrochemical and thermal stability. However, they are expensive and can liberate fluorine. They also require a non-aqueous solvent, usually N-methyl-2-pyrrolidone (NMP), in which the binder is dissolved and active material as well as conductive additive are dispersed. After coating onto the current collector this solvent has to be removed and recovered in a drying step.

More recently aqueous binder systems have been introduced for both ecological and economic reasons. For example styrene-butadiene rubber (SBR) as the primary binder and sodium carboxymethyl cellulose (CMC) as thickening/setting agent are used in Li-ion batteries, offering several advantages over non-aqueous binders.¹ However, these aqueous systems still introduce an organic binder into the electrode which has limited electrochemical and thermal stability. The latter restricts the drying step to temperatures well below the onset of binder decomposition. More elevated drying temperatures can be desirable for nanosized active materials, such as LiFePO₄ of LiMn_{1-y}Fe_{y}PO₄, due to their highly increased specific surface area, which more strongly adsorbs a larger amount of water that has to be removed in order to avoid detrimental side reactions in the battery, such as liberation of HF from LiPF₆ as electrolyte salt.

The only inorganic binders that have been proposed for battery electrodes up to now are polysilicates, e.g. lithium polysilicate,² which, however, due to their strong basicity are not compatible with many active electrode materials, such as lithium metal phosphates.

In battery electrodes composed of nanosized particles the number of interparticle contacts per volume is much larger than for bigger particles: for a given particle and packing geometry the number of contacts per volume is inversely proportional to the cube of the particle size. For example, reduction of the particle size from 10 μm to 0.1 μm increases the number of interparticle contacts by a factor of (10/0.1)³=1.000.000. Therefore, electrodes composed of nanoparticles can be mechanically strong even if each interparticle contact is weak (the adhesion of Geckos' nanohairy toes to a surface relies on the same principle). In contrast to electrodes from micrometer sized particles they do not require a polymeric binder which wraps around the particles (like PVdF) or which makes large surface area contact with them (like SBR). Instead in case of nanoparticles it suffices to strengthen the interparticle contacts with a binder that wets the particles surface and creates a neck at the contact points, thus increasing the cross sectional area of the contacts. Stress forces created by bending of the electrode during battery manufacture or by volumetric changes of the active material during discharging or recharging of the battery can be supported without fracture due to the division of these forces through the highly increased number of contact points between the nanoparticles and with the current collector.

Since a binder which wets the surface of the active material may cover the entire particle surface it has to be permeable for the electroactive species (Li⁺-ions in case of Li-batteries). Alternatively, the binder can be added in form of nanoparticles of a material that adheres strongly to active material and conductive additive as well as to the current collector of the electrode, but leaves most of the active materials surface free for electrolyte access.

Surface coating of cathode active materials for Li-batteries with oxides, such as MgO, Al₂O₃, SiO₂, TiO₂, SnO₂, ZrO₂ and Li₂O.2B₂O₃ has been used to improve their stability by preventing direct contact with the electrolyte or suppress phase transition.³ As a result side reactions, such as electrolyte oxidation or reduction and corrosion of the active material by the electrolyte or HF could be diminished. Li⁺-ion exchange between electrolyte and active material is not impeded, as long as the coating is thin enough.

### General Description of the Invention

The aim of the present invention is to provide an electrode material containing an improved inorganic binder used in the fabrication of battery electrodes to improve the cohesion of the active electrode material and the adhesion strength between the active electrode material and the current collector.

According to the present invention oxides serve as inorganic binder for battery electrodes, by providing cohesion between the particles of active materials and optional conductive additives as well as adhesion to the current collector.

In a preferred embodiment the inorganic binder forms a glass, such as lithium boron oxide compositions, which exhibits high Li⁺-ion conductivity.^{4, 5}

In another preferred embodiment the inorganic binder is an electronically conducting oxide, such as fluorine doped tin oxide (SnO₂:F) or indium tin oxide (ITO), which enhances electrical conduction through the electrode.

Lithium polyphosphate (LiPO₃)ₙ has also been proposed as protective coating for active materials in Li-batteries, due to its Li⁺-ion conductivity.^{6, 7}

According to the present invention phosphates or polyphosphates serve as inorganic binder for battery electrodes.

In a preferred embodiment the inorganic binder is a lithium phosphate or lithium polyphosphate. These are especially suited as binder for lithium metal phosphate cathode active materials, such as LiMnPO₄, LiFePO₄ or LiMn_{1-y}Fe_{y}PO₄, due to their inherent chemical compatibility. LiH₂PO₄ is a preferred precursor for the binder, since it condenses to lithium polyphosphate (LiPO₃)ₙ or Liₙ₊₂[(PO₃)ₙ₋₁PO₄] on heating above 150° C.⁸⁻¹¹

In another preferred embodiment the inorganic binder is a sodium phosphate or sodium polyphosphate, such as Graham's salt (NaPO₃)ₙ.

The pH of the phosphate binder solution can be adjusted in a wide range from acidic over neutral up to basic conditions, e.g. by addition phosphoric acid or alkali base or ammonia, in order to render the pH compatible with the active electrode material.

In another embodiment of the present invention other inorganic compounds that exhibit strong cohesion and adhesion to the electrode materials are used as binder for battery electrodes, e.g. carbonates, sulfates, borates, polyborates, aluminates, titanates or silicates and mixtures thereof and/or with phosphates.

In a preferred embodiment a phosphate, polyphosphate, borate, polyborate, phosphosilicate or borophosphosilicate is used as inorganic binder for carbon active materials (e.g. in anodes of Li-ion batteries) or carbon composite active materials (e.g. LiFePO₄/C, LiMnPO₄/C or Li Mn_{1-y}Fe_{y}PO₄/C).

In another embodiment the inorganic binder is combined with an organic polymer binder in order to take advantage of synergistic effects. The inorganic binder component creates a thin protecting coating on the active materials surface and acts as primer binder for strong attachment of the organic polymer binder component, which provides more flexible binding over larger distance.

In a preferred embodiment inorganic binder component provides cross-linking of the organic binder component, resulting in better mechanical strength and chemical resistance. For example, polyhydroxyl polymers, such as polyvinylalcohol (PVA), starch or cellulose derivatives have been used as water soluble organic binders in battery electrodes.^{12, 13} However, these polymers swell and partially dissolve in the electrolyte, unless their molecular weight is very high, which results in excessive viscosity of the slurry. According to the present invention, this problem is solved by cross-linking the organic polymer binder component, which can be of low molecular weight, by the inorganic binder component, e.g. by a phosphate binder through the formation of phosphate ester bridges.¹⁴

The present invention also provides an aqueous process for fabrication of battery electrodes.

In a preferred embodiment the active electrode material and optionally conductive additives are mixed in water with a soluble precursor of the inorganic binder, spread on the current collector and dried to form an electrode with inorganic binder.

In another preferred embodiment the active electrode material and optionally conductive additives are mixed with nanoparticles of the inorganic binder, dispersed in a liquid, preferentially water, spread on the current collector and dried to form an electrode with inorganic binder.

In a further preferred embodiment the active electrode material and optionally conductive additives are mixed with a colloidal dispersion of the inorganic binder, spread on the current collector and dried to form an electrode with inorganic binder. According to the present invention certain inorganic binders, e.g. carbonates, can also be obtained by reaction of suitable precursors, such as hydroxides, with a second precursor, such as carbon dioxide gas.

In another preferred embodiment the active electrode material and optionally conductive additives are mixed in water with the inorganic binder and the organic binder, spread on the current collector and dried to form an electrode with a combination of inorganic and organic binder.

The binding action of the proposed inorganic binders results mainly from physisorption or chemisorption after the removal of water. They are cheaper and stronger than organic binders, free of labile fluorine and do not require organic solvents. They are electrochemically as well as thermally more stable, thus not limiting the temperature of drying and enhancing the lifetime of the battery. Since they provide strong binding already at low concentration and have a high gravimetric density they improve the volumetric energy density of the electrode. In addition to their binding action inorganic binders may protect the active material from corrosion by the electrolyte and the electrolyte from electrochemical decomposition on the active materials surface.

### DETAILED DESCRIPTION OF THE INVENTION

The present invention will be described in detail with examples supported by figures.

### BRIEF DESCRIPTION OF THE FIGURES

FIG. 1 shows electrochemical performance of LiMn_{0.8}Fe_{0.2}PO₄/carbon nanocomposite electrode with 5% LiH₂PO₄ binder (♦) in comparison to 7.5% PVdF binder (▴).

FIG. 2 shows the cycling stability of a battery with LiMn_{0.8}Fe_{0.2}PO₄/carbon nanocomposite cathode containing 5% LiH₂PO₄ binder.

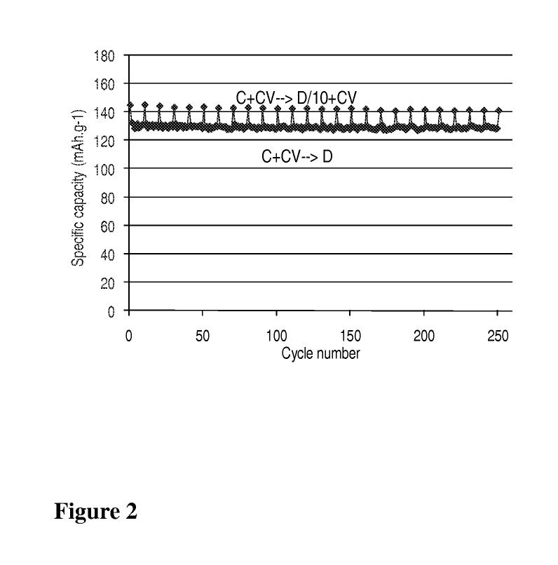

The following examples are intended to be merely illustrative of the present invention, and not limiting thereof in either scope or spirit.

### EXAMPLES

### Example 1

### Lithium Manganese/Iron Phosphate Cathode with Lithium Phosphate Binder

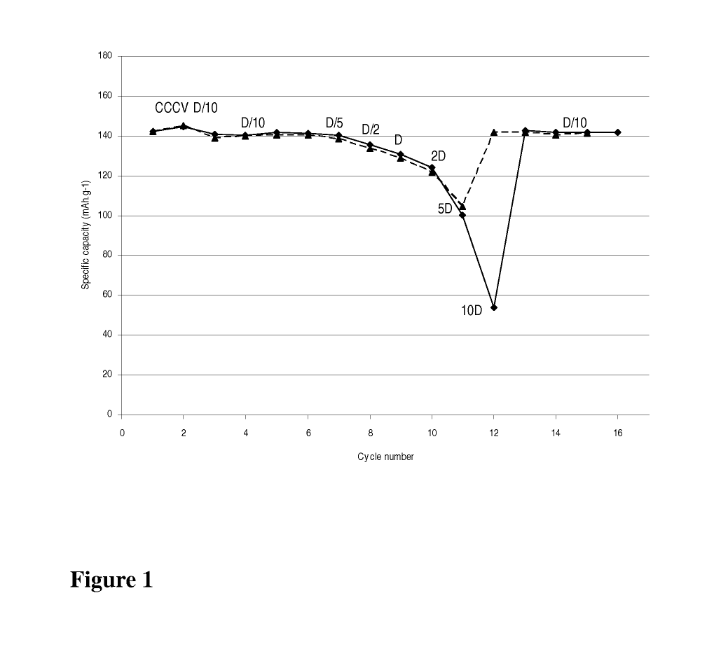

A LiMn_{0.8}Fe_{0.2}PO₄/carbon nanocomposite powder (1 g) is dispersed with pistil and mortar in a solution of 50 mg LiH₂PO₄ (Aldrich) in 2 mL water. After addition of 0.1 mL ethanol for improved wetting the dispersion is spread with a doctor blade onto a carbon coated aluminum foil and dried in air up to 200° C. The thus obtained coating exhibits excellent adhesion even on bending of the foil. Its electrochemical performance is equivalent to that with 7.5% PVdF as binder (FIG. 1).

### Example 2

### Lithium Manganese/Iron Phosphate Cathode with Sodium Polyphosphate Binder

A LiMn_{0.8}Fe_{0.2}PO₄/carbon nanocomposite powder (1 g) is dispersed with pistil and mortar in a solution of 50 mg sodium polyphosphate (NaPO₃)ₙ (Aldrich) in 2 mL water. Electrodes are prepared as described in example 1 and show similar performance.

### Example 3

### Lithium Manganese/Iron Phosphate Cathode with Lithium Phosphosilicate Binder

A LiMn_{0.8}Fe_{0.2}PO₄/carbon nanocomposite powder (1 g) is dispersed in a perl mill in a solution of 25 mg LiH₂PO₄ (Aldrich) and 25 mg Li₂Si₅O₁₁ (Aldrich) in 4 mL water (contrary to the strongly basic Li₂Si₅O₁₁ this solution has a neutral pH). Electrodes are prepared as described in example 1 and show similar performance.

### Example 4

### Lithium Manganese/Iron Phosphate Cathode with Titanium Dioxide Binder

A LiMn_{0.8}Fe_{0.2}PO₄/carbon nanocomposite powder (1 g) is dispersed with pistil and mortar in a colloidal solution of 50 mg TiO₂ of less than 15 nm average particle size in 2 mL water. Electrodes are prepared as described in example 1 and show similar performance.

### Example 5

### Lithium Manganese/Iron Phosphate Cathode with Lithium Phosphate Cross-Linked Polyvinyl Alcohol Binder

A LiMn_{0.8}Fe_{0.2}PO₄/carbon nanocomposite powder (3 g) is dispersed in a perl mill in a solution of 75 mg LiH₂PO₄ (Aldrich) and 75 mg polyvinyl alcohol (PVA, 87-89% hydrolyzed, average molecular weight 13000-23000, Aldrich) in 12 mL water. The dispersion is spread with a doctor blade onto a carbon coated aluminum foil and dried in air up to 150° C. The thus obtained coating exhibits excellent adhesion even on bending of the foil. Its electrochemical performance is equivalent to that with 7.5% PVdF as binder.

### Comparative Example 1

### Lithium Manganese/Iron Phosphate Cathode with PVdF Binder

A LiMn_{0.8}Fe_{0.2}PO₄/carbon nanocomposite powder (1 g) is dispersed with pistil and mortar in a solution of 75 mg PVdF (poly(vinylidene fluoride)) in 2 mL NMP (N-methyl-2-pyrrolidone). The dispersion is spread with a doctor blade onto a carbon coated aluminum foil and dried in air up to 150° C. The electrochemical performance of the obtained electrode is shown for comparison in FIG. 1.

### REFERENCES

1. Guerfi, A., Kaneko, M., Petitclerc, M., Mori, M. & Zaghib, K. LiFePO₄ water-soluble binder electrode for Li-ion batteries. Journal of Power Sources 163, 1047-1052 (2007).
2. Fauteux, D. G., Shi, J. & Massucco, N. Lithium ion electrolytic cell and method for fabrication same. U.S. Pat. No. 5,856,045 (1999).
3. Li, C. et al. Cathode materials modified by surface coating for lithium ion batteries. Electrochimica Acta 51, 3872-3883 (2006).
4. Amatucci, G. G. & Tarascon, J. M. Rechargeable battery cell having surface-treated lithiated intercalation positive electrode. U.S. Pat. No. 5,705,291 (1998).
5. Amatucci, G. G., Blyr, A., Sigala, C., Alfonse, P. & Tarascon, J. M. Surface treatments of Li₁₊ₓMn₂₋ₓO₄ spinels for improved elevated temperature performance. Solid State Ionics 104, 13-25 (1997).
6. Gauthier, M. et al. LiPO₃-based coating for collectors. U.S. Pat. No. 6,844,114 (2005).
7. Gauthier, M., Besner, S., Armand, M., Magnan, J.-F. & Hovington, P. Composite treatment with LiPO₃. U.S. Pat. No. 6,492,061 (2002).
8. Rashchi, F. & Finch, J. A. Polyphosphates: A review. Their chemistry and application with particular reference to mineral processing. Minerals Engineering 13, 1019-1035 (2000).
9. Thilo, E. & Grunze, H. Zur Chemie der kondensierten Phosphate und Arsenate 0.13. Der Entwässerungsverlauf der Dihydrogenmonophosphate des Li, Na, K und NH₄. Zeitschrift für Anorganische und Allgemeine Chemie 281, 262-283 (1955).
10. Benkhoucha, R. & Wunderlich, B. Crystallization During Polymerization of Lithium Dihydrogen Phosphate 0.1. Nucleation of Macromolecular Crystal from Oligomer Melt. Zeitschrift Fur Anorganische Und Allgemeine Chemie 444, 256-266 (1978).
11. Galogaza, V. M., Prodan, E. A., Sotnikovayuzhik, V. A., Peslyak, G. V. & Obradovic, L. Thermal Transformations of Lithium Phosphates. Journal of Thermal Analysis 31, 897-909 (1986).
12. Igarashi, I., Imai, K. & Maeda, K. Binder containing vinyl alcohol polymer, slurry, electrode, and secondary battery with nonaqueous electrolyte. U.S. Pat. No. 6,573,004 (2003).
13. Ryu, M. et al. Electrode Material containing polyvinyl alcohol as binder and rechargeable lithium battery comprising the same. WO 2007/083896 (2007).
14. Chaouat, M. et al. A Novel Cross-linked Poly(vinyl alcohol) (PVA) for Vascular Grafts. Advanced Functional Materials 18, 2855-2861 (2008).

1. An electrode material comprising an inorganic binder wherein said binder comprises a metal orthophosphate, a metal metaphosphate, a metal polyphosphate, fluorophosphates, a metal polyfluorophosphate, a metal carbonate, a metal borate, a metal polyborate, a metal fluoroborate, a metal polyfluoroborate, a metal sulfate, a metal fluorosulfate, an oxide compound, a fluoroxide compound, an electrically conducting oxide (e.g. fluorine doped tin oxide SnO₂:F or indium tin oxide ITO), a titanate, a metal aluminate, a metal fluoroaluminate, a metal silicate, a metal fluorosilicate, a metal borosilicate, a metal fluoroborosilicate, a metal phosphosilicate, fluorophosphosilicate, a metal borophosphosilicate, a metal fluoroborophosphosilicate, a metal aluminosilicate, a metal fluoroaluminosilicate, a metal aluminophosphosilicate, a metal fluoroaluminophosphosilicate or a mixture thereof.

2. The electrode material according to claim 1, wherein the binder comprises a lithium, sodium, potassium, ammonium, calcium, magnesium or aluminum orthophosphate (e.g. LiH₂PO₄, Li₂HPO₄, Li₃PO₄, NaH₂PO₄, Na₂HPO₄, Na₃PO₄, KH₂PO₄, K₂HPO₄, K₃PO₄, NH₄H₂PO₄, (NH₄)₂HPO₄, CaHPO₄, Ca₃(PO₄)₂, MgHPO₄, Mg₃(PO₄)₂, Al (PO₄), cyclic metaphosphate (e.g. (LiPO₃)ₙ, (NaPO₃)ₙ, (Ca(PO₃)₂)ₙ, (Mg(PO₃)₂)ₙ, (Al(PO₃)₃)O, linear polyphosphate (e.g. Liₙ₊₂[(PO₃)ₙ₋₁PO₄], Naₙ₊₂[(PO₃)ₙ₋₁PO₄], Kₙ₊₂[(PO₃)ₙ₋₁PO₄], Caₙ₊₁[(PO₃)₂ₙ₋₁PO₄], Mgₙ₊₁[(PO₃)₂ₙ₋₁PO₄], fluorophosphate (e.g. Li₂PO₃F, Na₂PO₃F, CaPO₃F, MgPO₃F) or polyfluorophosphate or a mixture thereof.

3. The electrode material according to claim 1, wherein the binder comprises a lithium, sodium, potassium, calcium or magnesium carbonate (e.g. Li₂CO₃, Na₂CO₃, K₂CO₃, CaCO₃, MgCO₃) or a mixture thereof.

4. The electrode material according to claim 1, wherein the binder comprises a lithium, sodium, potassium, calcium, magnesium or aluminum borate (e.g. LiBO₂, Li₂B₄O₇, NaBO₂, Na₂B₄O₇, KBO₂, K₂B₄O₇, CAB₄O₇, MgB₄O₇, polyborate, fluoroborate or polyfluoroborate or a mixture thereof.

5. The electrode material according to claim 1, wherein the binder comprises a lithium, sodium, potassium calcium, magnesium or aluminum sulfate or fluorosulfate (e.g. Li₂SO₄, Na₂SO₄, K₂SO₄, CaSO₄, MgSO₄, Al₂(SO₄)₃) or a mixture thereof.

6. The electrode material according to claim 1, wherein the binder comprises a lithium, sodium, potassium, boron, calcium, magnesium, aluminum, silicon, tin, titanium or zirconium oxide or fluoroxide (e.g. Al₂O₃, B₂O₃, CaO, K₂O, Li₂O, MgO, Na₂O, SiO₂, SnO₂, SnO_{y}F_{z}, TiO₂, ZrO₂) or a mixture thereof.

7. The electrode material according to claim 1, wherein the binder comprises a lithium borate glass (e.g. Li₂O.2B₂O₃).

8. The electrode material according to claim 1, wherein the binder comprises a lithium, sodium, potassium, calcium or magnesium aluminate or fluoroaluminate.

9. The electrode material according to claim 1, wherein the binder comprises a lithium, sodium, potassium, calcium or, magnesium silicate or fluorosilicate.

10. The electrode material according to claim 1, wherein the binder comprises a lithium, sodium, potassium, calcium or magnesium borosilicate, fluoroborosilicate, phosphosilicate, fluorophosphosilicate, borophosphosilicate, fluoroborophosphosilicate, aluminosilicate, fluoroaluminosilicate, aluminophosphosilicate or fluoroaluminophosphosilicate.

11. (canceled)

12. A primary or secondary battery comprising a negative electrode (anode), a positive electrode (cathode) and an electrolyte, wherein at least one of the said electrodes comprises the electrode material according to claim 1.

13. The battery of claim 1, wherein the cathode comprises a lithium transition metal oxide or fluoroxide (e.g. LiCoO₂, Li₁₋ₓCO_{y}Mn_{z}Ni_{1-y-z}O₂, Li₁₋ₓCO_{y}Ni_{1-y-z}M_{z}O₂, Li₁₋ₓMn_{1-y}M_{y}O₂ Li₁₋ₓMn_{2-y}M_{y}O₄).

14. The battery of claim 1, wherein the cathode comprises a lithium transition metal phosphate or fluorophosphates (e.g. Li₁₋ₓFePO₄, Li₁₋ₓMnPO₄Li₁₋ₓMn_{1-y}Fe_{y}PO₄).

15-18. (canceled)

19. A process for making a battery electrode, comprising:
a) mixing in water of active electrode material, optionally conductive additives, water soluble precursors or nanoparticles or a colloidal dispersion of an inorganic binder and optionally further additives to adjust pH, viscosity or wetting behavior of the mixture,
b) spreading this electrode mixture on a current collector,
c) drying the electrode by heating in air, inert gas atmosphere, vacuum or reactive gas atmosphere.

20. The process of claim 14, wherein the water soluble precursor of the binder comprises a metal orthophosphate, metaphosphate, polyphosphate, fluorophosphates or polyfluorophosphate or a mixture thereof.

21-39. (canceled)
